(19) United States
(12) Patent Application Publication
(10) Pub. No.: US 2014/0043137 A1
(43) Pub. Date: Feb. 13, 2014

(54) Lockable Container with Time-Controlled Remote Control

(71) Applicants: Douglas W. SMITH, Knoxville, TN (US); Richard B. Sparks, Knoxville, TN (US)

(72) Inventors: Douglas W. SMITH, Knoxville, TN (US); Richard B. Sparks, Knoxville, TN (US)

(21) Appl. No.: 13/934,737

(22) Filed: Jul. 3, 2013

Related U.S. Application Data
(63) Continuation of application No. 12/581,494, filed on Oct. 19, 2009, now abandoned.
(60) Provisional application No. 61/106,329, filed on Oct. 17, 2008.

(51) Int. Cl. G07C 9/00

(52) U.S. Cl. CPC G07C 9/00126
USPC 340/5.28

(57) ABSTRACT

Apparatus for limiting access to items only during pre-determined times, a lockable container system includes a lockable container assembly and a remote control unit. The remote control unit includes an input keypad, a display, a processor, and a transmitter. The lockable container assembly includes a receiver, a locking mechanism, and an indicator. The pre-determined time that the lockable container assembly is able to be unlocked is entered on the keypad. When the predetermined time arrives, the remote includes an operator that, when actuated, sends an unlock signal to the lockable container assembly. At other times, the lockable container assembly remains locked, thereby limiting access to its contents. In one embodiment, the container includes perforations that ensure the inside environment matches the environment outside the container.

### BACKGROUND OF THE INVENTION

1. Field of Invention

This invention pertains to a lockable container that opens only at preset limes.

### BRIEF SUMMARY OF THE INVENTION

In accordance with the invention, a lockable container assembly that has a time-controlled locking mechanism is used to limit access to items when willpower alone is not sufficient to prevent a person from accessing those items. For example, between-meal snacking and between-meal binge eating is controlled for dieters by storing desirable foods in lockable container assemblies that can only be unlocked at pre-determined times. In one embodiment, lockable container assemblies are designed to fit within a refrigerator, a freezer, and a pantry or cupboard. Each lockable container assembly includes a door and a locking mechanism. When closed the lockable container assembly completely encloses any food placed inside the lockable container assembly and denies access to the food until the container assembly is unlocked at a pre-programmed time. Sequestering the food from the user for pre-determined periods essentially removes the need for long-term willpower and/or impulse control in dieting, without the inconvenience of entirely removing food from the user's residence.

In one such embodiment, spoilage of food kept within the in-refrigerator, in-pantry, and in-freezer lockable container assemblies is minimized by increasing air flow between the inside and outside of the lockable container assemblies by perforations in the walls of the containers. The perforations are sufficiently sized and in number sufficient to allow adequate air flow between the outside and inside of the containers to minimize undesired temperature gradients and undesired air chemistry gradients. In this way, the perforations allow storing food in the lockable container with the environment inside the container closely matching the environment outside the container, such as a freezer or refrigerator compartment. Furthermore, the perforations are not so large as to allow the contents of the container to be removed through the perforations. In various such embodiments, one or more of the sides, back, top, and bottom of the container includes perforations.

In another example, access to video game cartridges, controllers and/or entertainment remote control units is limited to prevent children and/or others from spending too much time playing games or watching videos. The lockable container assembly limits access to the entertainment items except during pre-determined times.

The lockable container assemblies have a locking mechanism that receives a signal from a remote control. The signal causes the door of the lockable container assembly to unlock, thereby allowing access to the container. The remote control includes an input keypad, a display, a processor, and a transmitter. The input keypad allows for setting the pre-determined time and for unlocking the lockable container assembly. In one embodiment, the processor stores the pre-determined lime and compares that time to the current lime. When the pre-determined time arrives, the processor sends an unlock signal to a receiver in the lockable container assembly upon actuation by the user. The receiver in the lockable container assembly operates a locking mechanism that allows the door of the lockable container assembly to be opened. In one embodiment, the lockable container assembly includes an indicator that indicates that the locking mechanism has been operated, such as by an illuminated lamp or audible device.

In one embodiment, the total volume of multiple lockable container assemblies is minimized by a nested configuration. The container assemblies are nested when the containers do not contain any items. Such a configuration provides for more efficient storage and shipping of the assemblies.

In one embodiment, the apparatus for limiting access during predetermined times includes a container enclosing a space; a door attached to said container; a locking mechanism configured to latch said door in a locked position relative to said container; and a remote control unit in communication with said locking mechanism, said remote control unit causing said locking mechanism to unlatch said door from said container. In one such embodiment, the apparatus includes a plurality of perforations in at least one wall defining said container, said perforations dimensioned and configured to substantially equalize the environment inside said container with the environment outside said container. In another such embodiment, said remote control unit includes a transmitter in communication with a receiver in said locking mechanism. In still another such embodiment, said remote control unit includes a processor programmed to execute a process for setting a current time, setting an unlock time, and generating an unlock signal.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment of a lockable container assembly and a front view of one embodiment of a remote control unit;

FIG. 2 is a cutaway view of one embodiment of nested lockable container assemblies;

FIG. 3 is a block diagram showing one embodiment of the lockable container system;

FIG. 4 is a flow diagram of one embodiment of the logic for the remote control unit; and

FIG. 5 is a flow diagram of one embodiment of the method of using the lockable container system.

### DETAILED DESCRIPTION OF THE INVENTION

An apparatus and methods for limiting access to items only during predetermined times is disclosed. The apparatus is suitable for denying access to food and/or other items for pre-determined periods and allowing access to food during finite, pre-determined times.

FIG, 1 Illustrates a perspective view of one embodiment of a lockable container assembly 102 and a front view of one embodiment of a remote control unit 118. A lockable container system 100 includes at least one lockable container assembly 102 and a remote control unit 118. The container assembly 102 includes a door 104 and container 106, connected with hinges 112. The door 104 includes a locking mechanism 108 with a plunger 110. The plunger 110 engages a receptacle 114 in the container 106 to latch the door 104 in a locked position.

The container 106 includes sidewalls, a top, a bottom, and a back wall. In the illustrated embodiment the two sidewalls have perforations 116. In various embodiments, one or more of the sides, back, top, and bottom of the container 106 includes perforations 116. The perforations 116 have a size and number such that adequate air flow between the outside and inside of the containers is achieved to minimize undesired temperature gradients and undesired air chemistry gradients. In one such embodiment, the perforations 116 are sized to allow the contents of the container 106 to be visible from outside the container 106. Such an embodiment permits an inventory to be made of the contents without accessing the container 106. Additionally, the perforations 116 are not sufficiently large to allow the contents of the container assembly 102 to be accessed through the perforations 110. In yet another embodiment, the container 106 walls do not have holes or perforations 116.

The illustrated embodiment of the remote control unit 118 includes a display 120, a keypad 122, and an infrared LED 124. The keypad 122 allows entry of the pre-determined time and the current time and the selection of setting the time and unlocking the container assembly 102. In the illustrated embodiment, the keypad 122 is a numeric pad with special function keys. In other embodiments, the keypad 122 includes other types of controls, for example, buttons for causing the display digits to increment instead of entering the actual number value. In various embodiments, the keypad 122 includes a button, touchscreen, or membrane interface.

In the illustrated embodiment, the infrared LED (light emitting diode) 124 transmits the unlock signal to the container assembly 102. In other embodiments, the unlock signal is an electro-magnetic signal, such as a radiofrequency (RF) signal.

FIG. 2 illustrates a cutaway view of one embodiment of nested lockable container assemblies 102-A, 102-B, 102-C. The outside container assembly 102-A is dimensioned to fit in a pantry, cabinet, cupboard, or other location where dry goods are stored. In one embodiment, the assembly 102-A has dimensions of 17″H×16″W×15″D. The middle container assembly 102-B is dimensioned to fit in a refrigerator. In one embodiment, the assembly 102-B has dimensions of 13″H×15″W×14″D. The inside container assembly 102-C is dimensioned to fit in a freezer compartment. In one embodiment, the assembly 102-C has dimensions of 8″H×14″W×10″D. The three container assemblies 102-A, 102-B, 102-C fit together to minimize the volume of the assemblies 102, such as during storage and/or shipping. Each of the three container assemblies 102-A, 102-B, 102-C has perforations 116-A, 116-B, 116-C on the walls of the container 106.

The outside container assembly 102-A is illustrated with the door 104 open relative to the container 106-A. Visible on the outside surface of the door 104 is an indicator 202, an IR receiver 204, and a handle 206. In the illustrated embodiment, the indicator 202 is an LED or other lamp that illuminates when the container assembly 102 is in the unlocked state. The IR receiver 204 is responsive to the IR LED 124 of the remote control unit 118. That is, when the remote control unit 118 causes the IR LED 124 to send the unlock signal 306, the IR receiver 204 in the door 106 receives the unlock signal 306. The handle 206 provides a convenient way to open and move the door 104 when unlocked

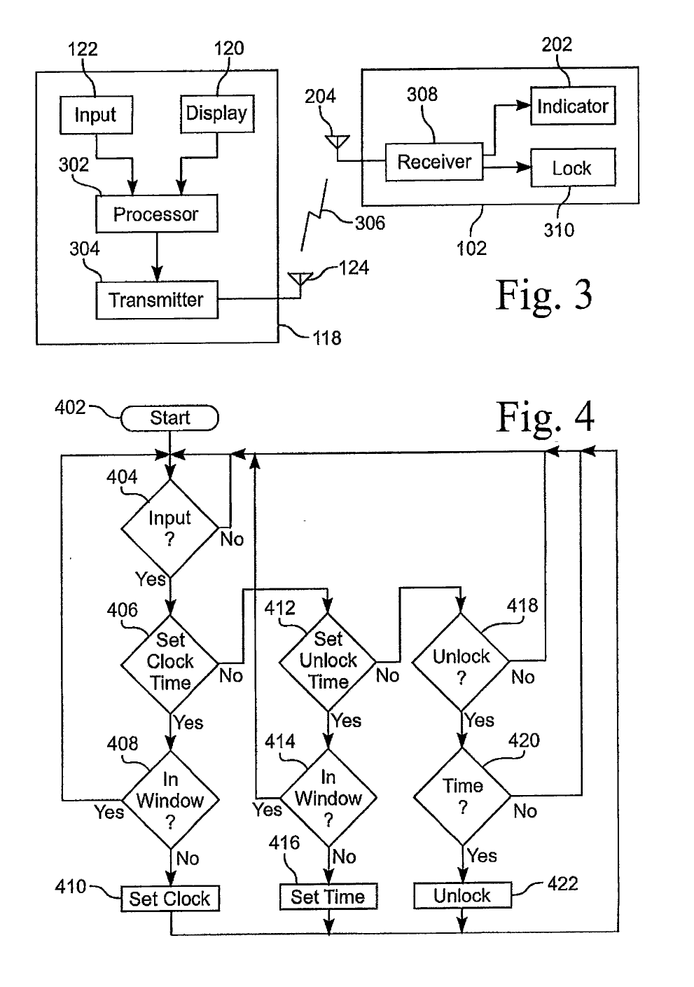

FIG. 3 illustrates a block diagram showing one embodiment of the lockable container system 100. The container system 100 includes a remote control unit 118 and the container assembly 102. The remote control unit 118 includes an input device 122, a display 120, a processor 302, a transmitter 304, and an antenna 124. The input device 122 is a keyboard or other device that accepts input from a user. The display 120 is a device that provides an output, such as visual or audible, of information corresponding to various inputs from the user.

As used herein, the processor 302 should be broadly construed to mean any computer or component thereof that executes software. The processor 302 includes a memory medium that stores software, a processing unit that executes the software, and input/output (I/O) units for communicating with external devices. Those skilled in the art will recognize that the memory medium associated with the processor 302 can be either internal or external to the processing unit of the processor without departing from the scope and spirit of the present invention.

In one embodiment the processor 302 is a specialized device for implementing the functions of the invention. Those skilled in the art will recognize that the processor 302 includes an input component, an output component, a storage component, and a processing component. The input component receives input from external devices, such as the input keyboard 122. The output component sends output to external devices, such as the display 120 and the transmitter 304. The storage component stores data and program code. In one embodiment, the storage component includes random access memory. In another embodiment, the storage component includes non-volatile memory. The processing component executes the instructions included in the software and routines.

In one embodiment, each of the functions identified herein are performed by one or more software routines executed by the processor 302. In another embodiment, one or more of the functions identified are performed by hardware and the remainder of the functions are performed by one or more software routines run by the processor 302. In still another embodiment, the functions are implemented with hardware, with the processor 302 providing routing and control of the entire container system 100.

The processor 302 executes software, or routines, for performing various functions. These routines can be discrete units of code or interrelated among themselves. Those skilled in the art will recognize that the various functions can be implemented as individual routines, or code snippets, or in various groupings without departing from the spirit and scope of the present invention. As used herein, software and routines are synonymous. However, in general, a routine refers to code that performs a specified function, whereas software is a more general term that may include more than one routine or perform more than one function.

The transmitter 304 receives an input from the processor 302, and the transmitter antenna 124 sends an unlock signal 306 to the receiver antenna 204 for the container assembly 102. The transmitter 304 converts the signal from the processor 302 to a signal usable by the transmitter antenna 124. The receiver 308 is responsive to the signal from receiver antenna 204.

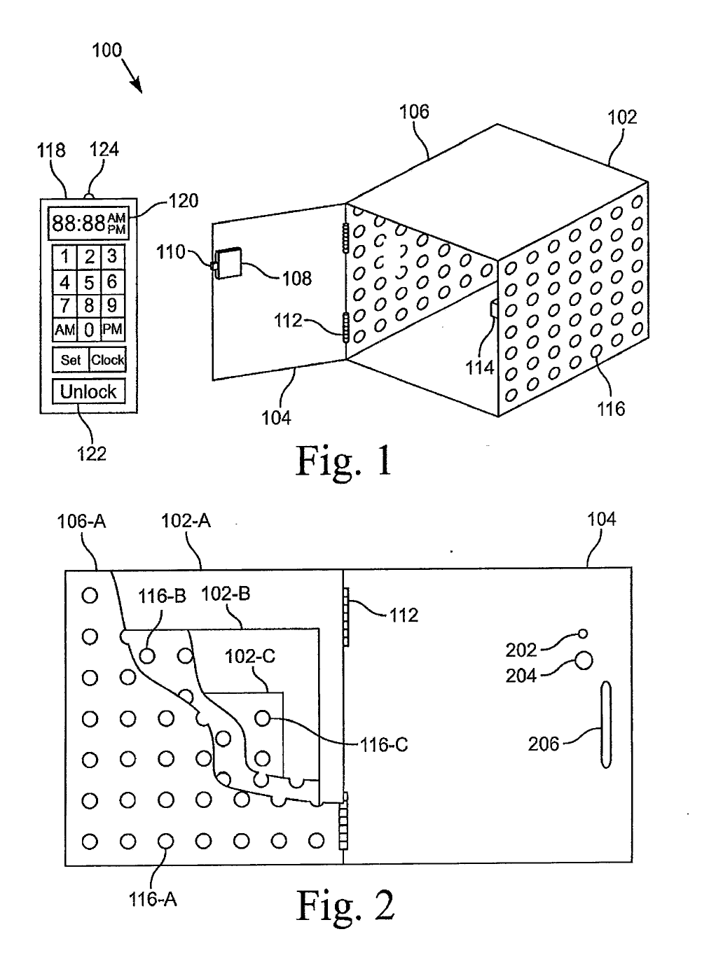

In the embodiment illustrated in FIGS. 1 and 2, the transmitter antenna 124 is an IR LED 124, the receiver antenna 204 is an IR receiver 204, and the unlock signal 306 is an infrared signal. In other embodiments, the unlock signal 306 is an electro-magnetic signal and the transmitter 304, the transmitter antenna 124, the receiver antenna 204, and the receiver 308 are devices that operate in the domain associated with that signal 306.

The container assembly 102 includes the receiving antenna 204, a receiver 308, a lock 301, and, in the illustrated embodiment, an indicator 202. Connected to the receiver 308 is a lock 310, which is the mechanism that latches and unlatches the locking mechanism 108. Upon receiving the unlock signal 308, the receiver 308 causes the lock 310 to operate the locking mechanism 108 to unlatch or unlock the container assembly 102. In the illustrated embodiment, the receiver 308 also is connected to an indicator 202, which provides visual and/or audible indication that the receiver 308 has received an unlock signal 306.

In another embodiment, the container assembly 102 includes a receiver processor that receives data from the remote control unit 118. The receiver processor has in input from the receiver 308 and provides outputs to the indicator 202 and lock 310. In various such embodiments, the receiver processor stores data, for example, one or more pre-determined unlock times, the receiver processor also includes a clock function for keeping track of the current time, and the receiver processor automatically unlocks the lock 310 when the current time equals the pre-determined unlock time. In such embodiments, the remote control unit 118 provides the input data for the receiver processor.

FIG. 4 illustrates a flow diagram of one embodiment of the logic for the remote control unit 118. The logic is performed by the processor 302 in the remote control unit 118 in one embodiment.

The first step 402 is to start the process, such as when power is applied to the remote control unit 118. The next step 404 is to determine if an input has been made on the remote control unit 118. If no input is detected, the process loops to continually check for an input. If an input is detected, three steps 406, 412, 418 are performed to determine how to process the input. Although illustrated sequentially, in various embodiments the steps 406, 412, 418 are performed in any order or even simultaneously. In the illustrated embodiment, if step 406 determines that the set clock input was not received, step 412 of checking if the set unlock time input was received is performed. If the set unlock time input was not received, step 418 of checking if the unlock input was received is performed.

The set clock input is the input entered by the user on the remote control unit 118 required to set the current time. For example, the user enters 0400PM to set the current time to 4:00 pm. If step 406 determines that the set clock input was received, step 408 of checking if the time to be set is within a selected window is performed. In order to set the clock in the remote control unit 118, the time to be set must be more than a pre-defined amount before the next unlock time. Otherwise, a user can set the current time to the pre-determined unlock time and defeat the lockable container system 100. For example, the current time cannot be set if it is within one hour before the next pre-determined unlock time. If the current time is within the window, then. the process loops back to the step 404 of checking the input. If the current time is not within the window, then the step 410 of setting the clock is performed. This step 410 sets the clock in the remote control unit 118 to the entered time, which is the current time.

The set unlock time input is the input entered by the user on the remote control unit 118 required to set the pre-determined unlock time. For example, the user enters 0500PM to set the unlock time to 5:00 pm. If step 412 determines that the set unlock time input was received, step 414 of checking if the current time is within a selected window is performed. That is, step 414 checks to ensure that the new unlock time is not too close to the current time so as to defeat the purpose of the lockable container system 100. For example, the pre-determined unlock time cannot be set if it is within one hour after the current time. In one embodiment, if the current time is within a specified amount after the last pre-determined unlock time, then the new unlock time is considered within the window. In this way, a new unlock time can be input if the container assembly 102 is currently unlocked. If the pre-determined unlock time is within the window, then the process loops back to the step 404 of checking the input. If the pre-determined unlock time is not within the window, then the step 416 of setting the pre-determined unlock time is performed. This step 416 sets the pre-determined unlock time in the remote control unit 118.

In one embodiment, the lockable container system 100 stores more than one pre-determined unlock time, which allows the container assembly 102 to be opened, or unlocked, more than once per day and/or more than once per week at different times and days. In such an embodiment, the processor 302 also includes the functions of allowing entry of multiple unlock times and of deleting an unlock time entry. In one such embodiment, the lockable container system 100 allows for the entry of the day of the week, for example, the container assembly 102 is to be unlocked Monday through Friday at one time and unlocked on Saturday at another time. In one such embodiment, the pre-determined unlock times are set as either a one-use time or a repeating time that would occur daily, weekly, or some other period. In another embodiment, the amount of time that entry into the lockable container system 100 is available is input and stored. For example, if the contents to be accessed is a video game, the access time window is set for the amount of time that the video game can be played, such as 2 hours. The video game can be removed and replaced in the lockable container system 100 within that window.

The unlock input is the input entered by the user on the remote control unit 118 required to unlock the container assembly 102. If step 418 determines that the unlock input was received, step 420 of checking if the current time is within a selected window is performed. For example, if the current time is within one hour alter the pre-determined unlock time, the unlock input will unlock the container assembly 102. In one embodiment, the duration of the selected window for accessing the container assembly 102 is a value that is input into the remote control unit 118.

If the pre-determined unlock time is not within the window, then the process loops back to the step 404 of checking the input. If the pre-determined unlock time is within the window, then the step 422 of unlocking the container assembly 102 is performed. This step 422 includes the processor 302 communicating with the transmitter 304 to send the unlock signal 306 to the container assembly 102.

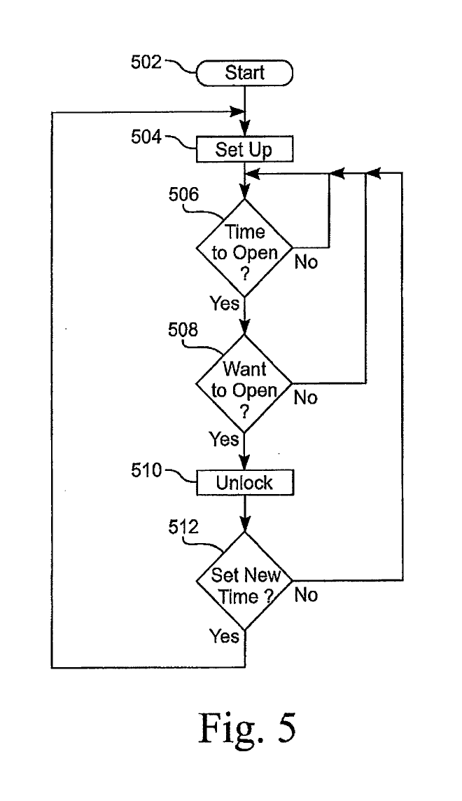

FIG. 5 illustrates a flow diagram of one embodiment of the method of using the lockable container system 100. The first step 402 is to start the process of using the system 100. After starting, the next step 504 is to set up the lockable container system 100. Setup includes locating each container assembly 102 where desired, for example, placing one in the freezer and another in the pantry. Setup also includes setting the current time and the pre-determined unlock time with the remote control unit 118.

The step 506 of checking to see if it is time to open the container assembly 102 is performed. If it is not time, the step 506 loops, if it is time, the next step 508 of deciding if the user wants to open the container assembly 102 is performed. If the user does not desire to access the contents of the container assembly 102, the user does not have to open the container assembly 102. In such a case, the process loops back to step 506 of checking if it is time to open the container assembly 102.

If the user desires to access the contents of the container assembly 102, the step 510 of unlocking is performed. The user operates the remote control unit 118 to unlock the container assembly 102. For the embodiment illustrated in FIGS. 1 and 2, the user places the remote control unit 118 in line-of-sight with the container assembly 102 and inputs unlock into the remote control unit 118. When the indicator 202 illuminates on the container assembly 102, the user grasps the handle 206 and opens the door 104, thereby gaining access to the contents of the container 106.

After the step 510 of unlocking, the user has the option of performing the step 512 of setting a new unlock time. Performing this step 512 at this point in the process is convenient because the user is already operating the remote control unit 118. If the user decides to set a new unlock time, the process loops back to step 504 of setup. If the user decides not to set a new unlock time, the process loops back to step 506 of checking if it is time to open the container assembly 102.

The lockable container system 100 includes various functions. The function of controlling multiple container assemblies 102 is implemented, in one embodiment, by the remote control unit 118, which operates to unlock a set of container assemblies 102.

From the foregoing description, it will be recognized by those skilled in the art that a lockable container system 100 has been provided.

While the methods disclosed herein have been described and shown with reference to particular steps performed in a particular order, it will be understood that these steps may be combined, sub-divided, or re-ordered to form an equivalent method without departing from the teachings of the present invention, Accordingly, unless specifically indicated herein, the order and grouping of the steps is not a limitation of the present invention.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for limiting access during pre-determined times, said apparatus comprising:
a container enclosing a space;
a door attached to said container;
a locking mechanism configured to latch said door in a locked position relative to said container; and
a remote control unit in communication with said locking mechanism, said remote control unit causing said locking mechanism to unlatch said door from said container.

2. The apparatus of claim 1 further including a plurality of perforations in at least one wall defining said container, said perforations dimensioned and configured to substantially equalize the environment inside said container with the environment outside said container.

3. The apparatus of claim 1 wherein said remote control unit includes a transmitter in communication with a receiver in said locking mechanism.

4. The apparatus of claim 1 wherein said remote control unit communicates with said locking mechanism by an infrared signal.

5. The apparatus of claim 1 wherein said remote control unit includes a processor programmed to execute a process for setting a current time, setting an unlock time, and generating an unlock signal.
